(19) United States
(12) Patent Application Publication
(10) Pub. No.: US 2019/0066378 A1
(43) Pub. Date: Feb. 28, 2019

(54) Personal communication via immersive computing environment

(71) Applicant: Blueprint Reality Inc., Vancouver (CA)

(72) Inventor: Benjamin James Sheftel, Vancouver (CA)

(21) Appl. No.: 15/684,005

(22) Filed: Aug. 23, 2017

(51) Int. Cl. G06T 19/00; H04L 29/06; H04N 5/272; H04N 7/15; A63F 13/65; A63F 13/30

(52) U.S. Cl. CPC G06T 19/006; H04L 67/38; H04L 65/1063; G06T 19/003; G06T 2219/024; H04N 7/157; A63F 13/65; A63F 13/30; H04N 5/272

(57) ABSTRACT

An immersive computing system generates a virtual reality or mixed reality video relating to a user of the system and transmits it to a user of a remote device. The remote device sends a video relating to the remote user to the user of the immersive system. The video from the remote user is incorporated into the virtual world of the immersive user, enabling personal communication between the remote user and the immersive user, without the immersive user needing to exit the virtual world. The video transmitted from the immersive system to the remote user may be a first-person or a third-person view. The remote device may be conventional and transmit a real-world video, or immersive and transmit a virtual or mixed reality video.

### TECHNICAL FIELD

This application relates to the field of computer-altered video production. In particular, it relates to a method and system for personal communication via at least one immersive computing system.

### BACKGROUND

Immersive computing systems tend to be isolating or exclusionary as they produce additional digital sensations that are experienced by a single user only. These sensations are difficult to express on 2D display devices, such as smart phones, televisions and web browsers, and they are also difficult to express to other users who are using an immersive computing system.

The current standard for visually communicating immersive experiences is to reuse the visual rendering of the virtual scene, which is sent to a headset to provide the immersive experience. However, the visual rendering output poses a number of problems from the standpoint of communication to the other person. For example, fast, erratic headset movement is expected, which is driven by the wearer's movement, specifically head rotation. This leads to transmission of a fast and erratic video to the other person in the communication. The same problem applies to users who communicate their immersive experience from a hand-held AR-enabled phone. Another problem is that the other person has no subject to visually address, because the view that is presented to them at all times is that which is seen through the eyes of the person in the immersive experience. Furthermore, the view that is presented to the other person is limited to a constrained perspective into the virtual, immersive scene.

While multiplayer applications for immersive computing systems exist, they are onerous from a technical perspective to implement and only allow communication to users who are online simultaneously in the same application. Also, this communication approach does not extend easily to 2D display devices.

This background information is provided to reveal information believed by the applicant to be of possible relevance to the present invention. No admission is necessarily intended, nor should be construed, that any of the preceding information constitutes prior art against the present invention.

### SUMMARY OF INVENTION

This invention enables personal communication through a virtual reality (VR) or augmented reality (AR) device that is being used to provide an immersive computing experience to a user. The invention disclosed herein is a cross-application and cross-medium platform, which allows users of immersive computing systems to broadcast a unique, 2D, virtual or mixed reality (MR) output from their devices to one or more other users, and have those users communicate back to the first user by way of their own conventional devices or immersive systems. Within any supported application, the system provides asset-agnostic connectivity so that a user can start or join a group of users across smartphones, tablets, PCs, and immersive devices, and speak face to face with the other users.

Disclosed herein is a method for enabling personal communication comprising the steps of: receiving, in an immersive computing system, a first video feed transmitted via a network from a source; creating, by the immersive computing system, a three-dimensional computer-generated scene comprising a virtual screen; adjusting the first video feed to fit the virtual screen; displaying a first view of the three-dimensional computer-generated scene with the adjusted first video feed on an immersive device within the immersive computing system; generating, by the immersive computing system, a second video feed, the second video feed being of a second view of the three-dimensional computer-generated scene; and transmitting the second video feed via the network to the source.

Further disclosed herein is a system for enabling personal communication comprising: a source that provides a first video feed; a network connected to the source; and an immersive computing system comprising an immersive device. The immersive computing system is connected via the network to the source and configured to: receive the first video feed; create a three-dimensional computer-generated scene comprising a virtual screen; adjust the first video feed to fit the virtual screen; display, on the immersive device, a first view of the three-dimensional computer-generated scene including the adjusted first video feed; generate a second video feed, the second video feed being of a second view of the three-dimensional computer-generated scene; and transmit the second video feed via the network to the source.

Still further disclosed herein is a non-transitory computer readable medium comprising computer-readable instructions, which, when executed by a processor cause an immersive computing system to: receive a first video feed transmitted via a network from a source; create a three-dimensional computer-generated scene comprising a virtual screen; adjust the first video feed to fit the virtual screen; display a first view of the three-dimensional computer-generated scene with the adjusted first video feed on an immersive device within the immersive computing system; generate a second video feed, the second video feed being of a second view of the three-dimensional computer-generated scene; and transmit the second video feed via the network to the source.

### BRIEF DESCRIPTION OF DRAWINGS

The following drawings illustrate an embodiment of the invention, and should not be construed as restricting the scope of the invention in any way. The drawings are not to scale.

FIG. 1 is a schematic diagram of a system for personal communication using an immersive computing system, according to an embodiment of the present invention.

FIG. 2 is a schematic diagram of a high level configuration of the system, according to an embodiment of the present invention.

FIG. 3 is a schematic diagram of a high level configuration of an alternate system, according to an embodiment of the present invention.

FIG. 4 shows a swimlane diagram for the main steps of user interaction with the system of FIG. 1.

FIG. 5 is a flowchart of the main steps an immersive computing system takes, according to an embodiment of the present invention.

FIG. 6 is a flowchart of the main steps a remote system takes when used to communicate with the immersive computing system, according to an embodiment of the present invention.

### DESCRIPTION

### A. Glossary

The term “augmented reality (AR)” refers to a view of a real-world scene that is superimposed with added computer-generated detail. The view of the real-world scene may be an actual view through glass, on which images can be generated, or it may be a video feed of the view that is obtained by a camera.

The term “virtual reality (VR)” refers to a scene that is entirely computer-generated and displayed in virtual reality goggles or a VR headset, and that changes to correspond to movement of the wearer of the goggles or headset. The wearer of the goggles can therefore look and “move” around in the virtual world created by the goggles.

The term “mixed reality (MR)” refers to the creation of a video of real-world objects in a virtual reality scene. For example, an MR video may include a person playing a virtual reality game composited with the computer-generated scenery in the game that surrounds the person.

The term “first-person” when referring to a view means the view as seen by a player in a video game, or as seen by the player's avatar.

The term “third-person” refers to a view of a player in a video game, or a view of the player's avatar. For example, the view could be from above, from in front, from behind or from the side.

An “immersive device” refers to a VR or AR headset, goggles or other device that can provide an immersive environment to the user of the immersive device.

A “non-immersive device” does not provide an AR or VR environment to the user of the non-immersive device, and includes devices such as laptops, smartphones and tablets.

The term “processor” is used to refer to any electronic circuit or group of circuits that perform calculations, and may include, for example, single or multicore processors, multiple processors, an ASIC (Application Specific Integrated Circuit), and dedicated circuits implemented, for example, on a reconfigurable device such as an FPGA (Field Programmable Gate Array). The processor performs the steps in the flowcharts, whether they are explicitly described as being executed by the processor or whether the execution thereby is implicit due to the steps being described as performed by code or a module. The processor, if comprised of multiple processors, may be located together or geographically separate from each other. The term includes virtual processors and machine instances as in cloud computing or local virtualization, which are ultimately grounded in physical processors.

The term “system” without qualification refers to the invention as a whole, i.e. a system for personal communication via an immersive computing environment. The system may include or use sub-systems.

The term “user” refers to a person who uses the system for communication with another person via an immersive computing environment. A user may use either a conventional device (e.g. smartphone or tablet) or a VR/AR device, which provides an immersive computing environment. In particular examples, the users are specified as being immersive users, in which case they use immersive computing devices. For example, they could be players engaging in a virtual reality game. In other examples, the users are specified as being conventional users, in which case they use a tablet or a smartphone, which is not configured or not being used for an immersive experience, or they may use any other suitable non-immersive device.

The term “chroma keying” refers to the removal of a background from a video that has a subject in the foreground. A color range in the video corresponding to the background is made transparent, so that when the video is overlaid on another scene or video, the subject appears to be in the other scene or video.

### B. Exemplary System

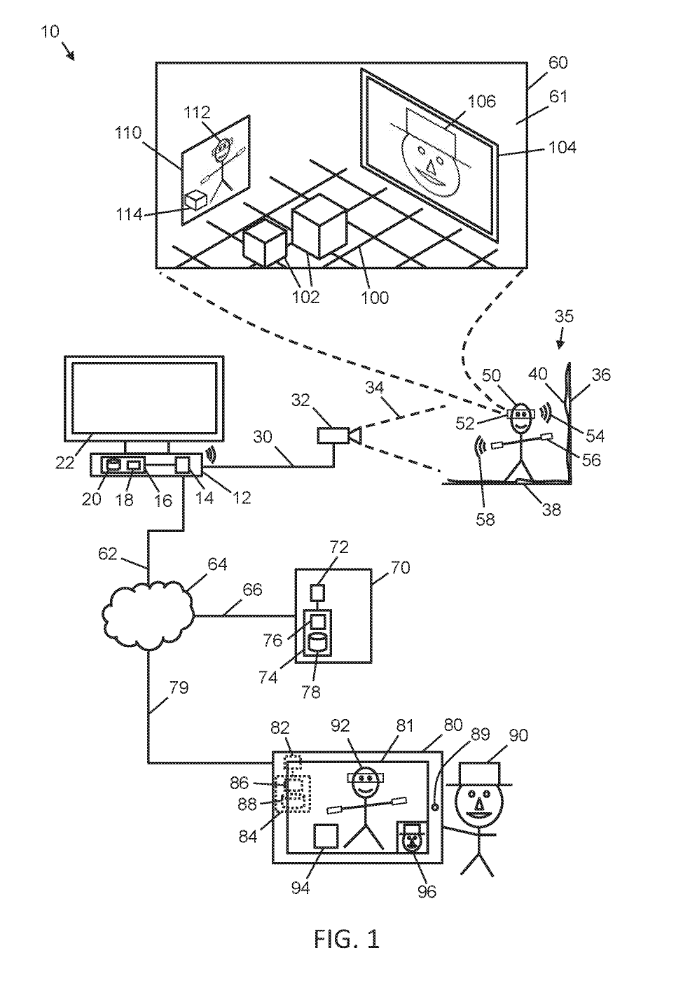

Referring to FIG. 1, there is shown an exemplary system 10 for personal communication via an immersive computing environment. The system 10 includes or interacts with an immersive processor such as a gaming machine 12. In other embodiments, the immersive processor may be a desktop computer, a laptop or a tablet, for example, or any other electronic device that is equipped with immersive devices or features to provide the necessary equivalent functionality of an immersive processor. The gaming machine 12 includes one or more processors 14 which are operably connected to non-transitory computer readable memory 16 included in the device. The system 10 includes computer readable instructions 18 (e.g. an application) stored in the memory 16 and computer readable data 20, also stored in the memory. Computer readable instructions 18 may be broken down into blocks of code or modules. The memory 16 may be divided into one or more constituent memories, of the same or different types. The gaming machine 12 optionally includes a display screen 22, operably connected to the processor(s) 14. The display screen 22 may be a traditional screen, a touch screen, a projector, an electronic ink display or any other technological device for displaying information.

The gaming machine 12 is connected via a wired or wireless connection 30 to a camera or device acting as a camera 32. Some embodiments may use a secondary processing device with a camera, which transmits the camera video feed back to the gaming machine 12 or other immersive processor. The camera 32 is directed such that its field of view 34 captures a background set 35. In this example, the background set 35 includes a wall 36 and floor 38, both covered with a green cloth 40 or other green screen. A user, in this case a immersive user 50, is present in the background set 35, and is wearing virtual reality goggles 52 that are wirelessly connected 54 to the gaming machine 12. Alternately, the goggles 52 are connected with a wired connection to the gaming machine 12. In other embodiments, the immersive user may wear AR goggles or may use a phone-based AR device. The immersive user 50 is also holding controls 56, which are also wirelessly connected 58 to the gaming machine 12. Under control of the processor 14 executing the application 18, the VR goggles 52 display to the immersive user 50 a view 60 of a scene 61 stored in data 20, which will be elaborated below.

The scene viewed by the camera 32 is chroma keyed to remove the green screen background and to add the immersive user 50 to a computer-generated virtual scene. A view of this virtual scene, with the added immersive user, is broadcast as an MR, on-the-fly video production.

The gaming machine 12 is connected via wired or wireless connection 62 to the internet 64, and further connected via wired or wireless connection 66 to server 70. The server 70 includes one or more processors 72 which are operably connected to non-transitory computer readable memory 74 included in the server. The server 70 includes computer readable instructions 76 (e.g. an application) stored in the memory 74 and computer readable data 78, also stored in the memory. Computer readable instructions 76 may be broken down into blocks of code or modules. The memory 74 may be divided into one or more constituent memories, of the same or different types. The server 70 may in other embodiments be multiple, constituent servers that are collocated or geographically distributed.

The server 70 is further connected, via connection 66, the internet 64 and wired or wireless connection 79 to an ordinary tablet 80, which is a non-immersive device. In other embodiments, a different non-immersive device may be used instead of a tablet, such as a smartphone, a laptop or a desktop computer. The server 70, under control of the processor 72 executing an application 76, receives communications from the gaming machine 12 and sends them to the tablet 80. Likewise, the server 70 receives communications from the tablet 80, and sends them to the gaming machine 12. The server 70 also keeps track of which users and/or user computing devices are online and signed into the server, and which users desire to communicate with each other via the server, and stores this information in data 78. The server 70 may store and/or transmit additional communication data in the form of chat messages (text, links, images, etc.) and more specific interaction concepts (voting mechanisms, in-app event triggering, etc.).

The tablet 80 includes one or more processors 82 which are operably connected to non-transitory computer readable memory 84 included in the tablet. The tablet 80 includes computer readable instructions 86 (e.g. an application) stored in the memory 84 and computer readable data 88, also stored in the memory. Computer readable instructions 86 may be broken down into blocks of code or modules. The memory 84 may be divided into one or more constituent memories, of the same or different types. The tablet 80 includes a display screen 81, operably connected to the processor(s) 82. The display screen 81 may be a traditional screen, a touch screen, a projector, an electronic ink display or any other technological device for displaying information. Also included in the tablet 80 is at least one camera 89. A further camera may be present in the reverse side of the tablet 80. The tablet is shown being used by a conventional user 90.

The conventional user 90 and the immersive user 50 are in communication with each other. Displayed on screen 81 of the tablet 80 is an MR video including an image 92 of the immersive user 50 and a virtual object 94 in the virtual immersive scene that is generated around the immersive user by the gaming machine 12. Also displayed on the screen 81 of the tablet 80 is a picture-in-picture 96 of the conventional user 90, which is captured by the camera 89. The display of the tablet is controlled by processor 82 executing an application 86. Data 88 may include details of friends that are immersive users with whom the conventional user can communicate using the system.

The view 60 of the scene 61, which is displayed by the goggles 52 worn by the immersive user 50, includes a virtual floor 100, virtual objects 102 and a virtual screen 104. The scene 61 created by the gaming machine 12 represents the virtual world that the immersive user is interacting with and therefore extends beyond the confines of the rendered view 60. The virtual screen 104 includes a processed, real-time video feed transmitted from the tablet 80, and is shown here displaying an image 106 of the conventional user 90. The video feed from the tablet 80 is processed so that it is skewed to fit into the perspective view of the virtual screen 104, and so that it is maintained within the frame of the virtual screen as the immersive user “moves” around in the scene 61 provided by the goggles 52. Also displayed in the goggles 52 is a second virtual screen 110, which shows the video feed that is being transmitted from the gaming machine 12 to the tablet 80. Here, the second virtual screen 110 includes an image 112 of the immersive user 50 surrounded by a computer-generated virtual scene, which includes, for example, an image 114 of virtual object 94.

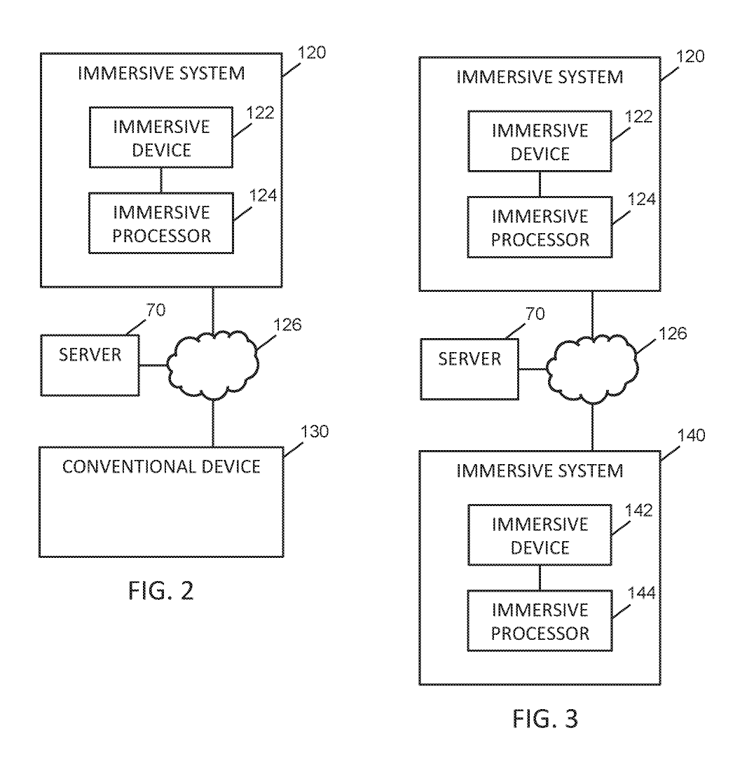

Referring to FIG. 2, a simplified diagram of the configuration of the system according to FIG. 1 is shown. An immersive system 120, which can be considered to be a local system, includes an immersive device 122 having a screen on which an immersive view of a computer-generated scene is displayed. The immersive device 122 may be VR goggles 52, AR goggles or a headset, for example. The display of the immersive view on the immersive device 122 is controlled by an immersive processor 124. The immersive processor 124 may be, for example, processor 14 or a device containing a processor as well as other components. The immersive processor 124 could be a gaming machine 12 or a personal computer, for example. Other components may be present in the immersive system, such as a microphone, earphones, hand controllers, haptic devices, other cameras for similar purposes, etc.

The immersive system 120 is shown connected to the network 126, which may be the internet, a cellular data network, or a combination of a cellular network and the internet. Also connected to the network 126 and the immersive system 120 is the server 70. A conventional device 130 is shown connected to the network 126, via which it is also connected to the server 70 and the immersive system 120. The conventional device is a non-immersive device, such as a tablet, laptop or a smartphone, and is a source of real-time, real-world video. The conventional device can be considered to be a remote source with respect to the immersive system 120.

FIG. 3 shows a simplified diagram of an alternate configuration of the system. The configuration is the same as for FIG. 2, except that the conventional device is replaced with another immersive system 140. As above, the immersive system 140 includes multiple components, of which one is an immersive device 142 on which a view of an immersive scene is displayed to a user. Another component is an immersive processor 144, which controls the output of the immersive device 142.

### C. Exemplary Method

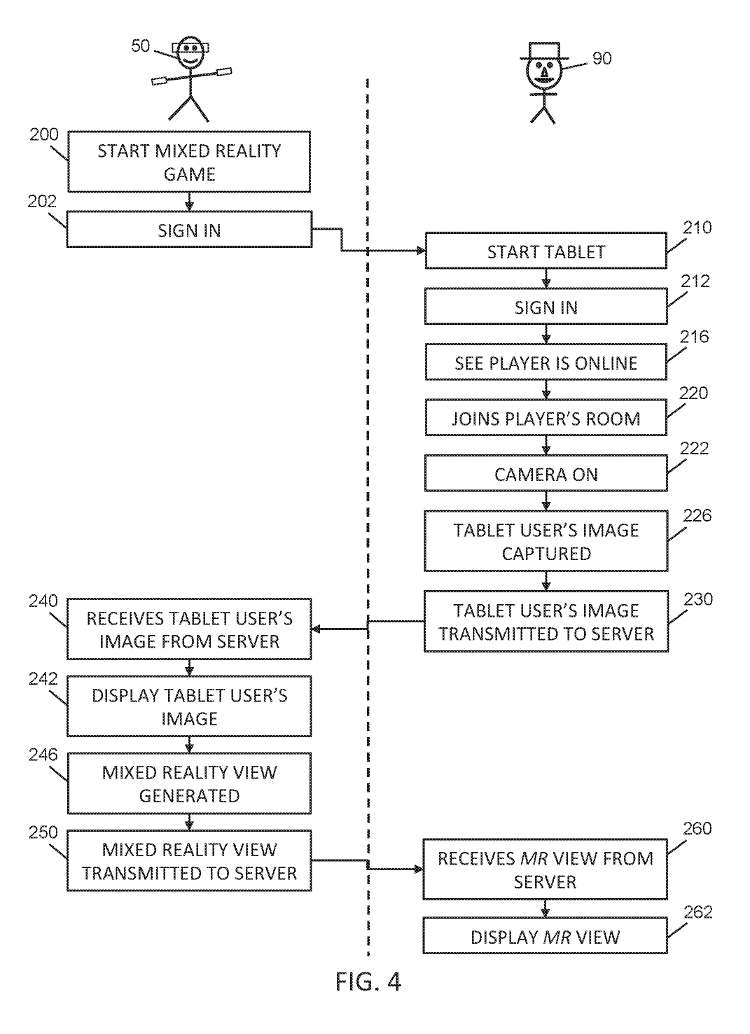

Referring to FIG. 4, the immersive user 50 (player) starts up an MR game on the gaming machine 12, in step 200, which involves joining a room, for example, in a virtual world. During the game, or in other cases before or after the game, the immersive user signs in, in step 202, to the server 70. In yet other cases, the immersive user is signed in automatically by the gaming machine 12.

Some time later (for example), the conventional user 90 (tablet user) switches the tablet 80 on, in step 210, and then signs into the server in step 212. Note that the immersive user 50 and conventional user 90 may sign into the server 70 in any order. As before, sign-in may be automatic. Registration may be needed before sign-in is possible. In other embodiments, another non-immersive device may be used instead of the tablet, such as a smartphone, a desktop computer or another non-immersive device.

When both the immersive user 50 and the conventional user 90 are now signed in at the server 70, the conventional user sees that the immersive user is online in step 216. In step 220, the conventional user 90 joins the immersive user's room. As a result, the camera 89 on the tablet 80 is switched on, in step 222. The conventional user 90 can only join the immersive user's room if the immersive user 50 has already acted to enter it.

The camera 89 then starts to capture the conventional user's image in step 226. As soon as the conventional user's image is captured, it is transmitted in real-time or near real-time from the tablet to the server 70, in step 230. Steps 226 and 230 occur concurrently, subject only to a minimal lag caused by the inherent limitations of the hardware used for capturing and transmitting the real-world video feed. In other embodiments, where an immersive device is being used instead of the tablet 80, a local process within or connected to the immersive device begins to generate either an MR output or a completely virtual output from a simulated scene. The virtual output can be from the perspective of either a primary virtual camera, which presents the view the user sees (first person), or a secondary virtual camera, which presents a view of the user in the virtual world (third person).

The gaming machine 12 used by the immersive user 50 receives the conventional user's image from the server in step 240, in as near real-time as the hardware permits. Concurrently with this, in step 242, the conventional user's image is displayed in the goggles 52 of the immersive user 50.

In step 246, the MR view is generated by the gaming machine 12. The MR view includes the image of the immersive user 50 removed from the green screen and composited into a computer-generated virtual scene. Alternately, in this step, the gaming machine generates a completely virtual output, either from a primary camera perspective or a secondary camera perspective within the virtual environment. The immersive user 50 has the choice of which scene to generate, and can make a selection to change from one to the other as desired.

In step 250, the MR view is transmitted to the server 70, and then, in step 260, the tablet 80 receives the MR view from the server. In step 262, the MR view is then displayed on the tablet. The conventional user can then observe the immersive user interacting with virtual and real-world objects. Steps 226-262 all occur concurrently and with as little lag as possible. In other embodiments, in which both users of the system are using an immersive computing device, each user will see a virtual scene similar to that of scene 60, i.e. including a virtual screen containing a video feed from the other user's local immersive computer system.

As well as the video connection being made between the immersive user and the conventional user, an audio connection is also made between the tablet and the gaming machine so that they can talk to each other as well as see a video stream of each other.

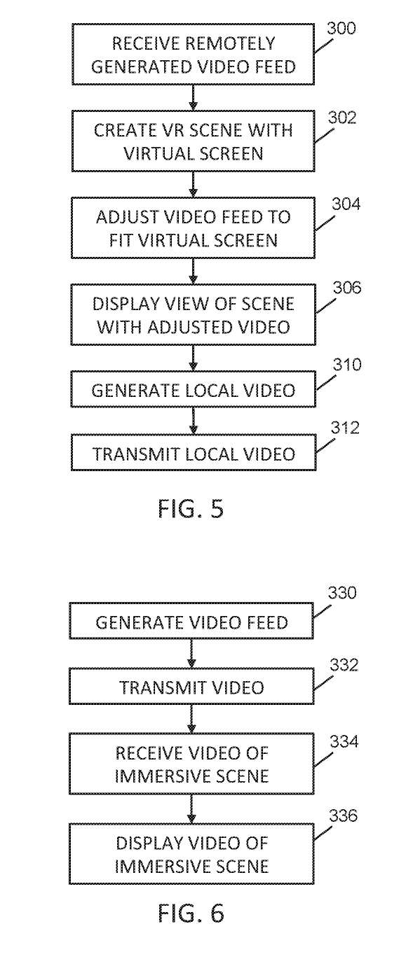

Referring to FIG. 5, a flowchart of the steps performed by the immersive computing system 120 is shown. The steps are performed under the control of the immersive processor 124, which forms part of the immersive system 120. In step 300, the immersive system 120 receives the external video feed generated by a remote source, such as a non-immersive device 130 or any other immersive system 140. The video feed may be a real-world video feed received from a camera on a non-immersive device, an entirely virtual reality video feed that is generated by the remote source, or a mixed reality video feed generated by the remote source.

In step 302, the immersive system 120 creates a three-dimensional computer-generated scene comprising a virtual screen 104 or adds the virtual screen to an existing scene. As the remotely generated video is being received continuously, the scene needs to be created once, only at the beginning when the video is first received. As the video continues to be received, the scene subsequently needs to be rendered at each frame, rather than created. In some embodiments, the virtual screen 104 may already exist in the virtual scene, e.g. as a blank screen which is “turned off”. The scene is local to the immersive system and is a VR scene. The VR scene may incorporate another virtual screen 110 showing an MR view of the user of the immersive computing system, or a first person view of the user in the virtual scene.

In step 304, the immersive computer system 120 adjusts the video feed from the remote source to fit the virtual screen 104 in the VR scene. This involves skewing, resizing, curving, cropping or otherwise deforming the overall shape of the video to fit the virtual screen 104. This is because the virtual screen 104 may be flat but viewed from an angle, curved, a perspective view, or partially obscured by another virtual object.

In step 306, the immersive system 120 displays on the immersive device 122 a view of the three-dimensional computer-generated scene, which includes the virtual screen 104 and the adjusted video feed on the virtual screen 104. The view depends on the virtual position and orientation of the immersive user in the virtual scene, as determined at least in part by the position and orientation of the immersive device in the real world.

In step 310, the immersive system 120 generates a local video feed of another view of the three-dimensional computer-generated scene, which includes, for example, a view of the immersive user surrounded by the VR scene, i.e. a third-person MR view. Alternately, this view may be the same view as displayed in step 306, i.e. the first-person view.

Generating the third-person MR view involves videoing an immersive user of the immersive computing system with a green screen background to create a raw video stream. The green screen background is then removed from the raw video stream to result in a subject video stream. The subject video stream is then composited into the second view of the three-dimensional computer-generated scene to result in the locally generated video feed.

In step 312, the immersive system 120 transmits the locally generated video feed via the network and server 70 to the remote source.

Referring to FIG. 6, a flowchart is shown of the steps performed by the remote source, whether it be a conventional device 130 or a further immersive system 140. The steps are performed under the control of a processor in the remote source. In step 330, the remote source generates a video feed. The video feed may be a real-world video feed received from a camera on the remote source, an entirely virtual reality video feed that is generated by the remote source, or a mixed reality video feed generated by the remote source.

In step 332, the remote source transmits the video to the immersive system 120. Transmission of the video is via the network and server 70.

In step 334, the remote source receives the video feed that is generated by the immersive system 120. In step 336, the remote source displays the video received from the immersive system 120.

### D. Variations

While the present embodiment describes the best presently contemplated mode of carrying out the subject matter disclosed and claimed herein, other embodiments are possible.

In other embodiments, more than two users can be connected, with always at least one of them using an immersive computing environment. In this situation, a conventional user sees video feeds from each of the other users displayed on the tablet or other non-immersive device. Each of these video feeds can be a real-world video stream, an MR video stream or an entirely virtual video stream. Users that are using an immersive computing device can see, in their VR world, a virtual screen for each of the other users. Each of these virtual screens includes a real-world video stream, an MR video stream or an entirely virtual video stream. A management process may be included to control the display of between one and all of the other users' outputs, and to switch between them if desired.

Any user of the system may choose to override their default visual output with an alternate perspective. For smartphones, this means switching from a front-facing to back-facing camera. For immersive computing systems, this includes the activation of alternate MR or virtual camera objects, each of which has its own operational behaviour. This allows the users a high amount of flexibility in the creation of engaging and understandable visual output for the other users.

Any user may choose to transmit multiple outputs in parallel to other users. This involves having multiple camera perspectives and multiple transmission connections active at once. Other users may choose to view one or more of the streams on their device at a time.

The picture-in-picture view of a conventional user on the user's device may be switched on and off by the user. The second virtual screen 110 may also be switched on and off by the immersive user.

While the green screen has been described as being green, other colors are also possible for the background screen.

Alternative background removal methods may be employed instead of chroma keying. One example is accessing depth data for each pixel from a depth-sensing camera and discarding pixels of the camera feed behind the player, who is in the foreground. Another is by pre-sampling the background colors in the camera feed and discarding pixels that are similar to that sample. The main requirement is that the background be digitally removable from a video of a subject in the foreground.

The video feeds that are transmitted may include audio, or the audio may be transmitted in a separate audio connection.

Additional room data may be created and transmitted to users, such as chat logs or other participation mechanisms.

Control over an immersive user's presentation may be granted to other users in the room, for example by exposing buttons to switch between the immersive user's first person and third person perspectives. These controls may trigger a single perspective from the immersive user's processor to be swapped for another perspective, or may, in the case where the immersive processor is transmitting multiple streams simultaneously, swap the stream which is being displayed on the user's device. Controls may also trigger screenshot capture, recording functionality, or in-application feedback for the immersive user such as visual or aural digital feedback.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail and repetitions of steps and features have been omitted to avoid unnecessarily obscuring the invention. Accordingly, the specification and drawings are to be regarded in an illustrative, rather than a restrictive, sense.

The detailed description has been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, understood to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more tangible or non-transient media readable by a computer or processor. The code modules may be stored in any computer storage system or device, such as hard disk drives, optical drives, solid state memories, etc. The methods may alternatively be embodied partly or wholly in specialized computer hardware, such as ASIC or FPGA circuitry.

It will be clear to one having skill in the art that further variations to the specific details disclosed herein can be made, resulting in other embodiments that are within the scope of the invention disclosed. Steps in the flowcharts may be performed in a different order, other steps may be added, or one or more may be removed without altering the main function of the system. Flowcharts from different figures may be combined in different ways. Configurations described herein are examples only and actual values of such depend on the specific embodiment. Accordingly, the scope of the invention is to be construed in accordance with the substance defined by the following claims.

1. A method for enabling personal communication comprising the steps of:
receiving, in an immersive computing system, a first video feed transmitted via a network from a source;
creating, by the immersive computing system, a three-dimensional computer-generated scene comprising a virtual screen;
adjusting the first video feed to fit the virtual screen;
displaying a first view of the three-dimensional computer-generated scene with the adjusted first video feed on an immersive device within the immersive computing system;
generating, by the immersive computing system, a second video feed, the second video feed being of a second view of the three-dimensional computer-generated scene; and
transmitting the second video feed via the network to the source.

2. The method according to claim 1, wherein:
the source is a non-immersive computing device; and
the first video feed is a real-world video feed;
the method further comprising:
receiving the first video feed from a camera on the non-immersive computing device; and
displaying the second video feed on the non-immersive computing device.

3. The method according to claim 1, wherein the second view is a first-person view corresponding to an immersive user of the immersive computing system.

4. The method according to claim 3, further comprising adjusting the second view of the three-dimensional computer-generated scene in response to movement of the immersive device.

5. The method according to claim 1, further comprising:
videoing an immersive user of the immersive computing system with a digitally removable background to create a raw video stream;
removing the background from the raw video stream to result in a subject video stream;
compositing the subject video stream into the second view of the three-dimensional computer-generated scene to result in the second video feed.

6. The method according to claim 1, further comprising:
receiving, by the immersive computing system, a selection from a user of the immersive computing system of either a first-person view or a third-person view; and
generating the second video feed according to the selection.

7. The method according to claim 1, wherein:
the source is another immersive computing system; and
the first video feed is another computer-generated video feed;
the method further comprising:
generating the first video feed by the other immersive computing system; and
displaying the second video feed on another immersive computing device connected to the other immersive computing system.

8. The method according to claim 7, wherein:
the first video feed is a first person view corresponding to an immersive user of the other immersive computing system.

9. The method according to claim 7, further comprising:
videoing an immersive user of the other immersive computing system with a digitally removable background to create a raw video stream;
removing the background from the raw video stream to result in a subject video stream;
compositing the subject video stream into the first video feed.

10. The method according to claim 1, wherein the first video feed and the second video feed are transmitted via a server connected to the network.

11. The method according to claim 1, further comprising making an audio connection between the source and the immersive computing system.

12. The method of claim 1, wherein the second view is identical to the first view.

13. The method of claim 1, further comprising displaying, in the first view, a second virtual screen showing the second view.

14. A system for enabling personal communication comprising:
a source that provides a first video feed;
a network connected to the source; and
an immersive computing system comprising an immersive device, the immersive computing system connected via the network to the source and configured to:
receive the first video feed;
create a three-dimensional computer-generated scene comprising a virtual screen;
adjust the first video feed to fit the virtual screen;
display, on the immersive device, a first view of the three-dimensional computer-generated scene including the adjusted first video feed;
generate a second video feed, the second video feed being of a second view of the three-dimensional computer-generated scene; and
transmit the second video feed via the network to the source.

15. The system according to claim 14, wherein:
the source is a non-immersive computing device comprising a camera;
the first video feed is a real-world video feed obtained by the camera; and
the second video feed is displayed on the non-immersive computing device.

16. The system according to claim 14, wherein:
the second view is a first-person view corresponding to an immersive user of the immersive computing system; and
the immersive computing system is further configured to adjust the second view of the three-dimensional computer-generated scene in response to movement of the immersive device.

17. The system according to claim 14, wherein the second video feed comprises a video of an immersive user of the immersive computing system with a background removed, the video of the immersive user being composited into the second view of the three-dimensional computer-generated scene.

18. The system according to claim 14, wherein the immersive computing system is further configured to:
receive a selection from a user of the immersive computing system of either a first-person view or a third-person view; and
generate the second video feed according to the selection.

19. The system according to claim 18, wherein the user of the immersive computing system is one of multiple users virtually present in the three-dimensional computer-generated scene.

20. The system according to claim 14, wherein:
the source is another immersive computing system; and
the first video feed is another computer-generated video feed;
and the other immersive computing system is configured to:
generate the first video feed; and
display the second video feed on another immersive computing device connected to the other immersive computing system.

21. The system according to claim 20, wherein the first video feed is either:
a first-person view corresponding to an immersive user of the other immersive computing system; or
a third-person view of the immersive user of the other immersive computing system.

22. The system according to claim 14, further comprising a server connected to the network, wherein the first video feed and the second video feed are transmitted via the server.

23. The system according to claim 14, further comprising an audio connection between the source and the immersive computing system.

24. A non-transitory computer readable medium comprising computer-readable instructions, which, when executed by a processor cause an immersive computing system to:
receive a first video feed transmitted via a network from a source;
create a three-dimensional computer-generated scene comprising a virtual screen;
adjust the first video feed to fit the virtual screen;
display a first view of the three-dimensional computer-generated scene with the adjusted first video feed on an immersive device within the immersive computing system;
generate a second video feed, the second video feed being of a second view of the three-dimensional computer-generated scene; and
transmit the second video feed via the network to the source.
